(19) United States
(12) Patent Application Publication
(10) Pub. No.: US 2025/0238068 A1
(43) Pub. Date: Jul. 24, 2025

(54) APPARATUS, SYSTEM, AND METHOD FOR REGULATING POWER CONSUMPTION OF PROCESSORS BASED ON TELEMETRY DATA

(71) Applicant: Meta Platforms Technologies, LLC, Menlo Park, CA (US)

(72) Inventors: Tomonari Tohara, Sunnyvale, CA (US); Lavanya Subramanian, Santa Clara, CA (US); Vlad Fruchter, Los Altos, CA (US); Reza Tusi, San Jose, CA (US); Weiping Liu, Fremont, CA (US); Vignesh Vivekraja, Santa Clara, CA (US); Javid Jaffari, San Diego, CA (US); Nishant Sitapara, Denver, CO (US)

(21) Appl. No.: 18/416,952

(22) Filed: Jan. 19, 2024

(51) Int. Cl. G06F 1/324

(52) U.S. Cl. CPC G06F 1/324

(57) ABSTRACT

An apparatus that facilitates and/or supports regulating power consumption of processors based on telemetry data may include a processor and a controller communicatively coupled to the processor. The controller may be configured to determine, based at least in part on telemetry data received from the processor, that an amount of power consumed by the processor exceeds a threshold. The controller may also be configured to cause the processor to reduce power consumption in response to determining that the amount of power exceeds the threshold. Various other apparatuses, systems, and methods are also disclosed.

### BRIEF DESCRIPTION OF DRAWINGS

The accompanying drawings illustrate a number of example embodiments and are a part of the specification. Together with the following description, these drawings demonstrate and explain various principles of the instant disclosure.

FIG. 1 is an illustration of an exemplary apparatus for regulating power consumption of processors based on telemetry data according to one or more implementations of this disclosure.

FIG. 2 is an illustration of an exemplary implementation of a communication bus between a processor and a controller responsible for regulating power consumption of the processor based on telemetry data according to one or more implementations of this disclosure.

FIG. 3 is an illustration of exemplary telemetry data that facilitates the regulation of power consumption by a processor according to one or more implementations of this disclosure.

FIG. 4 is an illustration of an exemplary system for regulating power consumption of processors based on telemetry data according to one or more implementations of this disclosure.

FIG. 5 is a flow diagram of an exemplary method for regulating power consumption of processors based on telemetry data according to one or more implementations of this disclosure.

FIG. 6 is an illustration of exemplary augmented-reality glasses that may be used in connection with embodiments of this disclosure.

FIG. 7 is an illustration of an exemplary virtual-reality headset that may be used in connection with embodiments of this disclosure.

While the exemplary embodiments described herein are susceptible to various modifications and alternative forms, specific embodiments have been shown by way of example in the appendices and will be described in detail herein. However, the exemplary embodiments described herein are not intended to be limited to the particular forms disclosed. Rather, the instant disclosure covers all modifications, combinations, equivalents, and alternatives falling within this disclosure.

### DETAILED DESCRIPTION OF EXEMPLARY EMBODIMENTS

The present disclosure is generally directed to apparatuses, systems, and methods for regulating power consumption of processors based on telemetry data. As will be explained in greater detail below, these apparatuses, systems, and methods may provide numerous features and benefits.

In some examples, processors (such as digital signal processors) may require and/or consume certain amounts of power, voltage, and/or current to operate and/or run optimally or even properly. Accordingly, these processors may be unable to achieve peak performance or even function well or properly without sufficient power, voltage, and/or current. Unfortunately, in some scenarios, certain power sources may be unable to source and/or provide sufficient power, voltage, and/or current to support peak performance and/or full functionality of such processors. For example, in a battery-powered system, a digital signal processor may rely on and/or draw power sourced by a battery. In this example, if the battery's power level drops below a certain threshold, the digital signal processor may need to consume more power than is available in the battery to achieve acceptable performance and/or functionality, especially for transient power-intensive operations, instructions, and/or spikes.

In some examples, to avoid poor performance and/or functionality or peak power-consumption spikes during periods of insufficient power, the digital signal processor may need to modify its power consumption and/or requirements. For example, a digital signal processor may rely on and/or draw power from a low battery whose peak sourcing capabilities have been limited. In this example, to modify its power consumption and/or requirements due to the low battery, the digital signal processor may operate on a slower clock signal and/or a lower voltage level. Accordingly, by modifying its power consumption and/or requirements in this way, the digital signal processor may be able to continue functioning properly-even through transient power-intensive operations, instructions, and/or spikes-despite the low battery.

In some examples, a controller may be able to regulate the power consumption of the digital signal processor based at least in part on power telemetry. For example, a controller may receive power telemetry data from the digital signal processor. In this example, the power telemetry data may indicate and/or identify certain instructions executed by the digital signal processor and/or memory accessed performed by the digital signal processor. The controller may then determine and/or estimate the amount of power needed and/or consumed by the processor based at least in part on the power telemetry data. If that amount of power exceeds a certain threshold (e.g., the amount of power available in the battery), then the controller may direct and/or cause the processor to reduce its power consumption. By doing so, the controller may improve the digital signal processor's performance under the power of the battery and/or extend the cycle or lifetime of the battery.

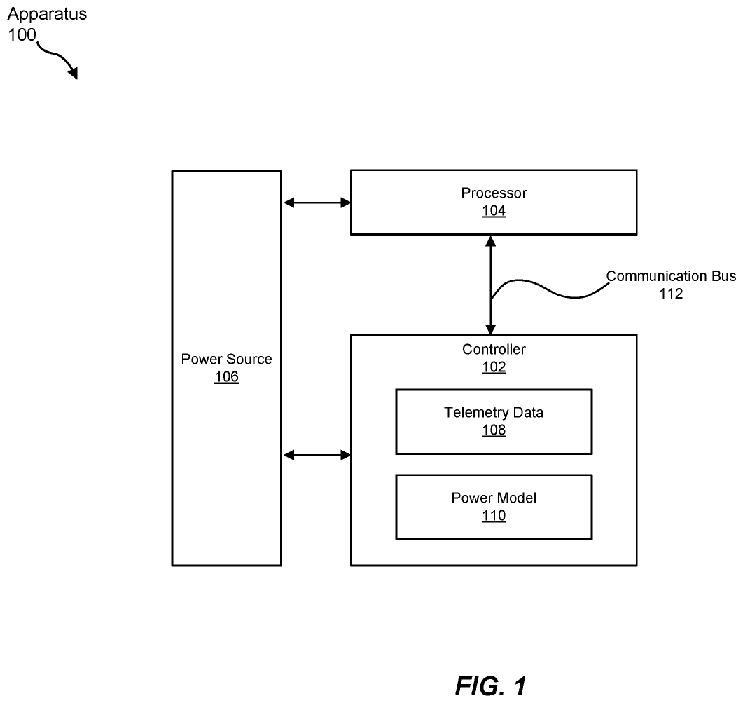

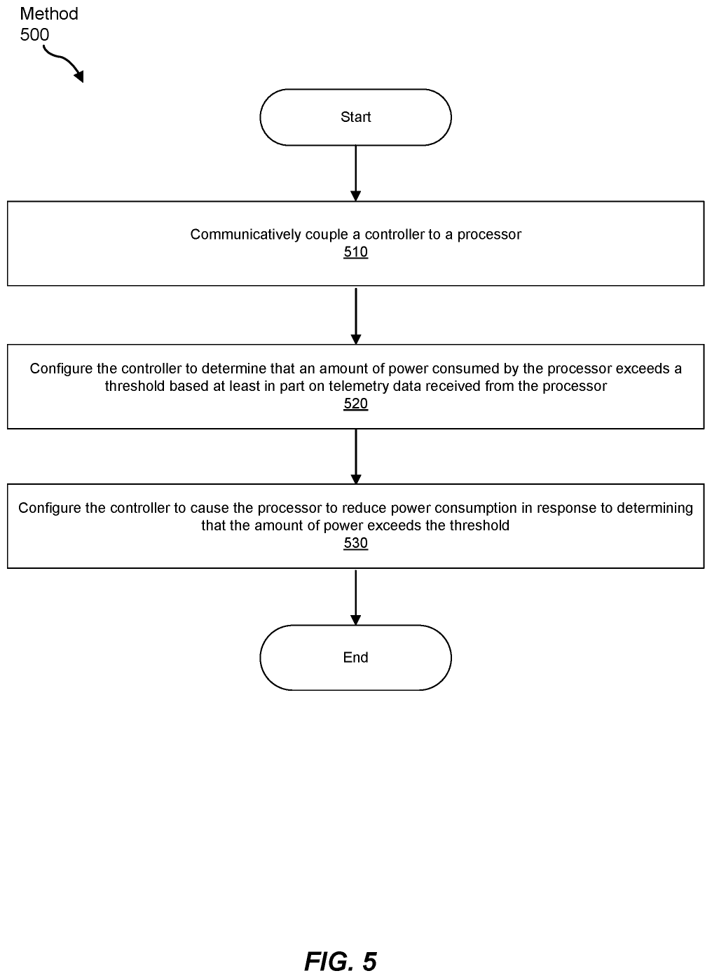

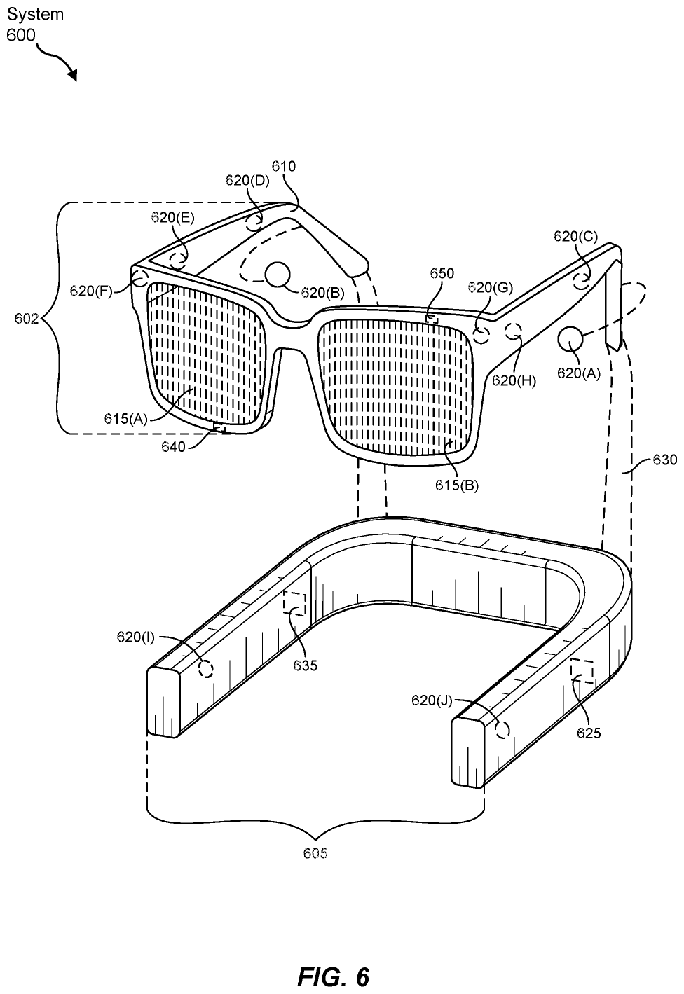

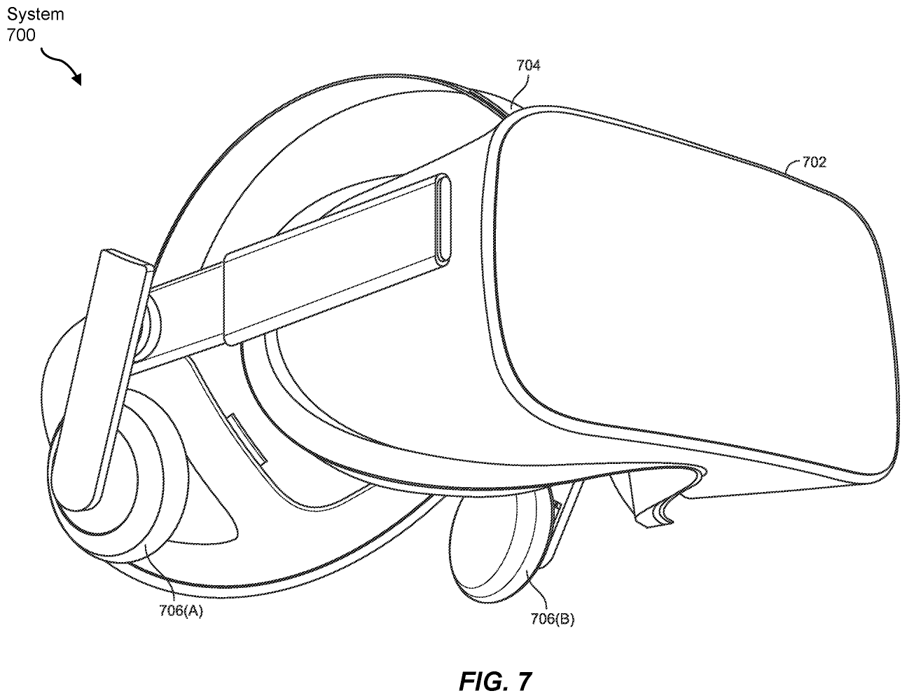

The following will provide, with reference to FIGS. 1-4, detailed descriptions of exemplary apparatuses, devices, systems, components, and corresponding configurations or implementations for regulating power consumption of processors based on telemetry data. In addition, detailed descriptions of methods for regulating power consumption of processors based on telemetry data will be provided in connection with FIG. 5. The discussion corresponding to FIGS. 6 and 7 will provide detailed descriptions of types of exemplary artificial-reality devices, wearables, and/or associated systems capable of regulating power consumption of processors based on telemetry data.

FIG. 1 illustrates an exemplary apparatus 100 for regulating power consumption of processors based on telemetry data. As illustrated in FIG. 1, apparatus 100 may include and/or represent a controller 102, a processor 104, and/or a power source 106. In some examples, controller 102 may be communicatively coupled to processor 104 via a communication bus 112. In one example, controller 102 may be configured and/or programmed to determine that an amount of power consumed by the processor exceeds a threshold based at least in part on telemetry data 108 received from processor 104. In this example, controller 102 may be further configured and/or programmed to cause the processor to reduce and/or decrease power consumption in response to determining that the amount of power consumed by the processor exceeds the threshold.

In some examples, power source 106 may be electrically coupled to processor 104 and/or controller 102. In one example, power source 106 may be configured to provide, deliver, and/or source power, voltage, and/or current to processor 104 and/or controller 102. In this example, processor 104 and/or controller 102 may be configured to draw power from power source 106. Examples of power source 106 include, without limitation, batteries, power converters and/or transformers, alternating current (AC) sources, direct current (DC) sources, AC outlets, AC/DC converters electrically coupled to AC outlets, combinations or variations of one or more of the same, and/or any other suitable power sources.

In some examples, communication bus 112 may facilitate and/or support communicating telemetry data 108 from processor 104 to controller 102. In one example, processor 104 may convey telemetry data 108 to controller 102 on a periodic basis (e.g., each clock cycle, every microsecond, every millisecond, etc.). Additionally or alternatively, controller 102 may analyze and/or evaluate telemetry data 108 on a periodic basis (e.g., each clock cycle, every microsecond, every millisecond, etc.) to continuously monitor the power consumption and/or power requirements of processor 104, especially in view of the amount of power available in power source 106 and/or the current-sourcing limitations of power source 106.

In some examples, telemetry data 108 may indicate, suggest, identify, and/or specify instructions executed, operations performed, and/or memory accessed by processor 104. For example, telemetry data 108 may include and/or represent evidence of various instructions executed by processor 104 during a certain period (e.g., each clock cycle, every microsecond, every millisecond, etc.). In one example, such instructions may have each been executed by one of various arithmetic logic units (ALUs), binary multipliers, floating point units (FPUs), and/or any other execution units included in and/or implemented on processor 104.

In some examples, communication bus 112 may be configured, arranged, and/or programmed to indicate and/or identify which instructions were executed by processor 104 during a certain period (e.g., each clock cycle, every microsecond, every millisecond, etc.). In one example, communication bus 112 may include and/or represent a parallel bus and/or various signals (e.g., hardware signals, clock signals, wires, traces, etc.) that collectively indicate, to controller 102, one or more instructions executed by processor 104 each clock cycle. Additionally or alternatively, communication bus 112 may include and/or represent a serial bus—such as an inter-integrated circuit (I²C) bus, a serial peripheral interface (SPI) bus, or the like—that indicates, to controller 102, one or more instructions executed by processor 104 each clock cycle.

In some examples, controller 102 may be configured to calculate, estimate, and/or extrapolate the amount of power consumed by processor 104 by applying the evidence of instructions executed by processor 104 to a power model 110. In one example, when implemented by controller 102, power model 110 may convert and/or transform the evidence of instructions executed by processor 104 to amounts to power needed and/or consumed by processor 104 in connection with the execution of those instructions. Additionally or alternatively, when implemented by controller 102, power model 110 may weight the evidence of instructions executed by processor 104 commensurate with the amounts of power needed and/or consumed by processor 104 in connection with the execution of those instructions.

In some examples, power model 110 may include and/or represent a machine learning model and/or a lookup table that enables controller 102 to calculate and/or estimate the amounts of power needed by processor 104 to execute those instructions. In one example, power model 110 may include and/or represent a machine learning model trained using linear algebra and/or deep learning. In another example, power model 110 may include and/or represent a lookup table that identifies and/or specifies a conversion of instruction type to power consumed and/or power impact. Additionally or alternatively, power model 110 may enable controller 102 to calculate and/or estimate the amount of power consumed by processor 104 in executing those instructions over a certain period of interest by adding and/or summing up the power impact of each instance of the relevant instructions.

Additional examples of power model 110 include, without limitation, convolutional neural networks, recurrent neural networks, supervised learning models, unsupervised learning models, linear regression models, logistic regression models, decision trees, support vector machine models, Naive Bayes models, k-nearest neighbor models, k-means models, random forest models, combinations or variations of one or more of the same, and/or any other suitable power models.

As a specific example, power model 110 may constitute and/or represent a convolutional neural network that includes various layers, such as one or more convolution layers, activation layers, pooling layers, and fully connected layers. In this example, telemetry data 108 may include and/or represent the most recent 500 microseconds of data (e.g., instruction data, memory-access data, etc.) outputted from processor 104 to controller 102 via communication bus 112. Controller 102 may pass telemetry data 108 through the convolutional neural network to estimate and/or predict the amount of power needed and/or consumed by processor 104.

In the convolutional neural network, telemetry data 108 may first encounter the convolution layer. In one example, at the convolution layer, the 500 microseconds of telemetry data 108 may be convolved using a filter and/or kernel. In particular, the convolution layer may cause controller 102 to slide a matrix function window over and/or across the 500 microseconds of telemetry data 108. Controller 102 may then record the resulting data convolved by the filter and/or kernel. In one example, one or more nodes included in the filter and/or kernel may be weighted by a certain magnitude and/or value (e.g., corresponding to the amount of power needed and/or consumed by processor 104 to execute specific instructions and/or perform certain memory accesses).

After completion of the convolution layer, the convolved representation of the telemetry data 108 may encounter the activation layer. At the activation layer, the convolved data may be subjected to a non-linear activation function. In one example, the activation layer may cause controller 102 to apply the non-linear activation function to the convolved data. By doing so, controller 102 may be able to identify and/or learn certain non-linear patterns, correlations, and/or relationships between different regions of the convolved data.

In some examples, controller 102 may apply one or more of these layers included in the convolutional neural network to telemetry data 108 multiple times. As telemetry data 108 completes all the layers, the convolutional neural network may render a prediction, estimation, and/or extrapolation of the amount of power needed and/or consumed by processor 104 based at least in part on telemetry data 108. In one example, the convolutional neural network and/or controller 102 may generate and/or produce digital feedback and/or response actions based at least in part on the prediction, estimation, and/or extrapolation of the amount of power.

In some examples, if the amount of power needed and/or consumed by processor 104 exceeds the threshold, controller 102 may cause processor 104 to reduce the power consumption. In one example, the threshold may correspond to, be commensurate with, and/or be based at least in part on the amount of power, voltage, and/or current available for consumption by processor 104 in power source 106. In this example, controller 102 may cause processor 104 to reduce and/or decrease its power consumption to avoid exceeding the amount of power available for consumption by processor 104, thereby potentially preserving and/or improving the performance of processor 104 despite limited power availability and/or current-sourcing capabilities.

In some examples, controller 102 may cause processor 104 to reduce and/or decrease its power consumption in a variety of different ways. For example, controller 102 may perform one or more actions that cause processor 104 to at least temporarily reduce and/or decrease its power consumption. In an additional example, controller 102 may direct and/or instruct processor 104 to at least temporarily reduce and/or decrease its power consumption by performing specific power-reduction actions and/or tasks. In another example, controller 102 may direct and/or instruct processor 104 to at least temporarily reduce and/or decrease its power consumption in any way selected and/or chosen by processor 104. In a further example, controller 102 may notify processor 104 that its power consumption is too high and/or exceeds the threshold, and processor 104 may then reduce and/or decrease its power consumption in response to that notification.

In some examples, the power consumption of processor 104 may be reduced and/or decreased in a variety of different ways. Examples of ways in which the power consumption of processor 104 is reduced and/or decreased include, without limitation, slowing the clock whose frequency controls the rate of instruction execution on processor 104, lengthening one or more pulses of the clock that controls the rate of instruction execution on processor 104, reducing the supply voltage provided to processor 104, slowing the rate that instructions are issued for execution on processor 104, and/or causing processor 104 to transition and/or switch from executing one instruction set to executing another instruction set (e.g., from vector instructions to sequential instructions), combinations or variations of one or more of the same, and/or any other suitable ways to reduce power consumption.

In some examples, controller 102 may be configured to cause processor 104 to reduce and/or decrease its power consumption to comply with the threshold. For example, controller 102 may monitor the power level and/or current-sourcing capabilities of power source 106. In this example, controller 102 may cause processor 104 to reduce its power consumption such that processor 104 needs and/or consumes an amount of power that complies with the power level and/or current-sourcing capabilities of power source 106. In other words, after having reduced its power consumption, processor 104 may be able to continue functioning properly-even through transient power-intensive operations, instructions, and/or spikes-despite limited power availability and/or current-sourcing capabilities. Accordingly, processor 104 may be able to avoid performing poorly and/or malfunctioning as a result of peak power-consumption spikes during periods of insufficient power availability and/or current-sourcing limitations.

In some examples, processor 104 may include and/or represent any type or form of processing hardware, device, and/or circuitry capable of executing an instruction set and/or accessing memory. In one example, processor 104 may include and/or represent a digital signal processor. Additional examples of processor 104 include, without limitation, microcontrollers, microprocessors, embedded processors, central processing units (CPUs), combinations or variations of one or more of the same, and/or any other suitable processors.

In some examples, controller 102 may include and/or represent one or more hardware-implemented processors, compute modules, and/or control logic units capable of interpreting and/or executing computer-readable instructions. Additionally or alternatively, controller 102 may include and/or represent any type or form of circuitry that processes, converts, and/or transforms input, data, and/or signals in one way or another. In one example, controller 102 may include and/or represent multiple circuits distributed across apparatus 100 and/or throughout a larger computing system. Examples of controller 102 include, without limitation, physical processors, CPUs, microprocessors, microcontrollers, field-programmable gate arrays (FPGAs), application-specific integrated circuits (ASICs), systems on chips (SoCs), control logic, parallel accelerated processors, tensor cores, integrated circuits, chiplets, portions of one or more of the same, variations or combinations of one or more of the same, and/or any other suitable controllers. In certain implementations, controller 102 and processor 104 may each constitute and/or represent a separate, individual, distinct, or standalone integrated circuit and/or package.

In some examples, apparatus 100 may include and/or represent any type or form of computing device and/or system. For example, apparatus 100 may include and/or represent a head-mounted display (HMD). In one example, the term “head-mounted display” and/or the abbreviation “HMD” may refer to any type or form of display device or system that is worn on or about a user's face and displays virtual content, such as computer-generated objects and/or augmented-reality (AR) content, to the user. Additional examples of apparatus 100 include, without limitation, personal computers, client devices, laptops, tablets, desktops, servers, cellular phones, Personal Digital Assistants (PDAs), multimedia players, embedded systems, wearable devices, gaming consoles, routers, switches, hubs, modems, bridges, repeaters, gateways, multiplexers, network adapters, network interfaces, portions of one or more of the same, variations or combinations of one or more of the same, and/or any other suitable apparatuses.

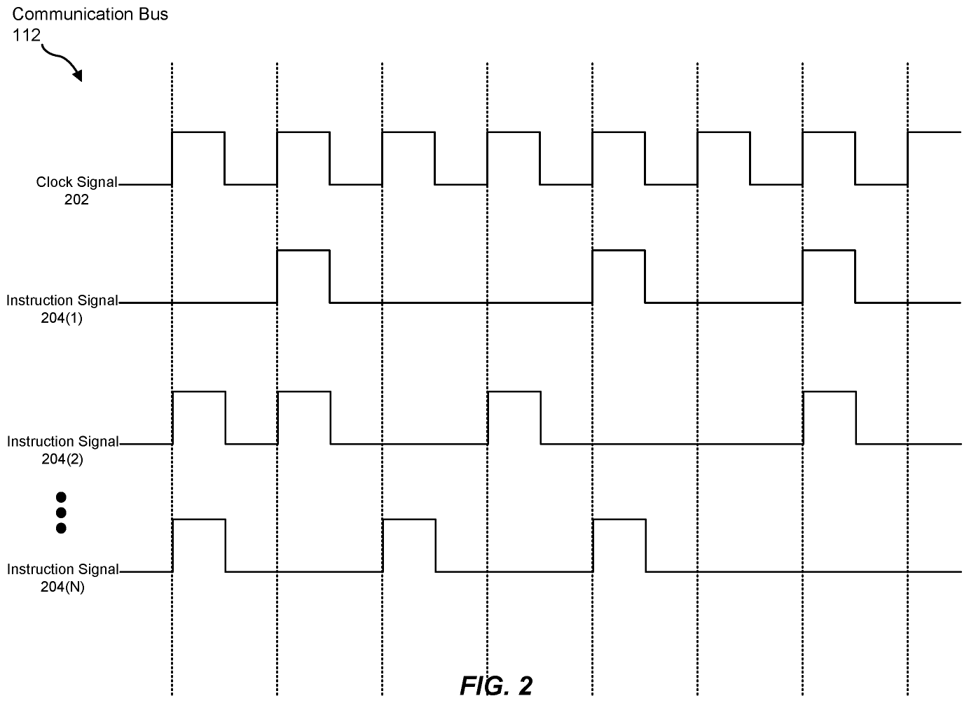

FIG. 2 illustrates an exemplary implementation of communication bus 112 that enables controller 102 to regulate the power consumption of processor 104 based on telemetry data 108. In some examples, communication bus 112 may include and/or represent certain devices, components, and/or features that perform and/or provide functionalities that are similar and/or identical to those described above in connection with FIG. 1. As illustrated in FIG. 2, communication bus 112 may include and/or represent various signals that communicate data and/or information about processor 104 to controller 102. For example, communication bus 112 may include and/or represent a clock signal 202 and/or instruction signals 204(1)-(N). In this example, clock signal 202 may indicate and/or show clock pulses and/or cycles that trigger and/or control the execution of instructions on processor 104. Additionally or alternatively, instruction signals 204(1)-(N) may indicate and/or show which instructions (e.g., of those included in a certain instruction set) are executed by processor 104 during any given clock cycle and/or for any given clock pulse reflected in clock signal 202.

As a specific example, communication bus 112 may communicate and/or notify controller 102 that the instructions represented by signals 204(2) and 204(N) were executed by processor 104 during the first clock pulse and/or cycle reflected in clock signal 202 in FIG. 2. In this example, communication bus 112 may also communicate and/or notify controller 102 that the instruction represented by signal 204(1) was not executed by processor 104 during the first clock pulse and/or cycle reflected in clock signal 202 in FIG. 2.

Continuing with this example, communication bus 112 may communicate and/or notify controller 102 that the instructions represented by signals 204(1) and 204(2) were executed by processor 104 during the second clock pulse and/or cycle reflected in clock signal 202 in FIG. 2. In this example, communication bus 112 may also communicate and/or notify controller 102 that the instruction represented by signal 204(N) was not executed by processor 104 during the second clock pulse and/or cycle reflected in clock signal 202 in FIG. 2.

Continuing with this example, communication bus 112 may communicate and/or notify controller 102 that the instruction represented by signal 204(N) was executed by processor 104 during the third clock pulse and/or cycle reflected in clock signal 202 in FIG. 2. In this example, communication bus 112 may also communicate and/or notify controller 102 that the instructions represented by signals 204(1) and 204(2) were not executed by processor 104 during the third clock pulse and/or cycle reflected in clock signal 202 in FIG. 2.

Continuing with this example, communication bus 112 may communicate and/or notify controller 102 that the instructions represented by signal 204(2) was executed by processor 104 during the fourth clock pulse and/or cycle reflected in clock signal 202 in FIG. 2. In this example, communication bus 112 may also communicate and/or notify controller 102 that the instruction represented by signals 204(1) and 204(N) were not executed by processor 104 during the fourth clock pulse and/or cycle reflected in clock signal 202 in FIG. 2.

Continuing with this example, communication bus 112 may communicate and/or notify controller 102 that the instructions represented by signals 204(1) and 204(N) were executed by processor 104 during the fifth clock pulse and/or cycle reflected in clock signal 202 in FIG. 2. In this example, communication bus 112 may also communicate and/or notify controller 102 that the instruction represented by signal 204(2) was not executed by processor 104 during the fifth clock pulse and/or cycle reflected in clock signal 202 in FIG. 2.

Continuing with this example, communication bus 112 may communicate and/or notify controller 102 that the instructions represented by signals 204(1), 204(2), 204(N) were not executed by processor 104 during the sixth clock pulse and/or cycle reflected in clock signal 202 in FIG. 2. Additionally or alternatively, communication bus 112 may communicate and/or notify controller 102 of various other instructions (although not necessarily illustrated in FIG. 2) that were executed and/or were not executed by processor 104 during the sixth clock pulse and/or cycle reflected in clock signal 202 in FIG. 2.

Continuing with this example, communication bus 112 may communicate and/or notify controller 102 that the instructions represented by signals 204(1) and 204(2) were executed by processor 104 during the seventh clock pulse and/or cycle reflected in clock signal 202 in FIG. 2. In this example, communication bus 112 may also communicate and/or notify controller 102 that the instruction represented by signal 204(N) was not executed by processor 104 during the seventh clock pulse and/or cycle reflected in clock signal 202 in FIG. 2. Additionally or alternatively, communication bus 112 may communicate and/or notify controller 102 of various other instructions (although not necessarily illustrated in FIG. 2) that were executed and/or were not executed by processor 104 during the first, second, third, fourth, fifth, sixth, and/or seventh clock pulses and/or cycles reflected in clock signal 202 in FIG. 2.

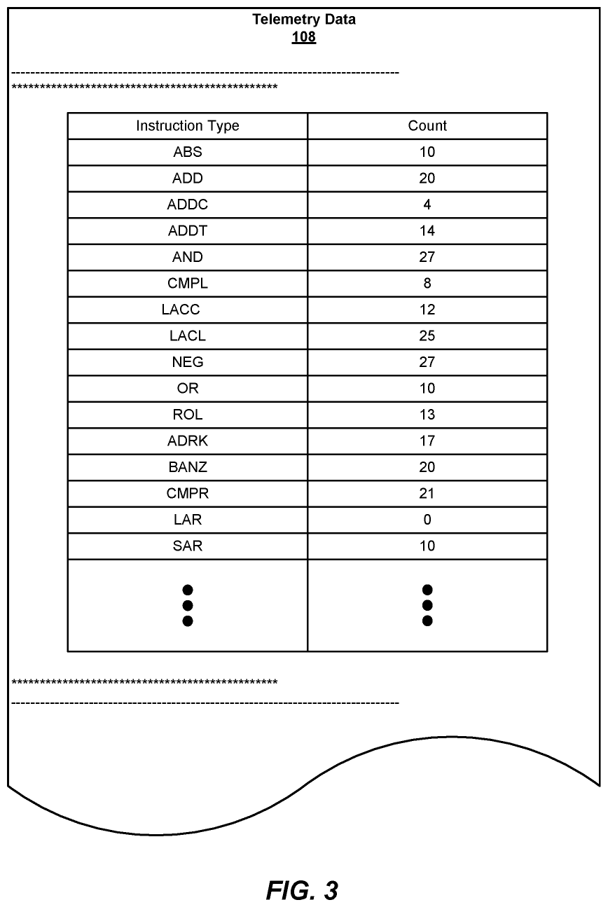

FIG. 3 illustrates an exemplary implementation of telemetry data 108 that received, stored, and/or maintained by controller 102 in connection with processor 104. As illustrated in FIG. 3, telemetry data 108 may identify, indicate, and/or specify which instructions were executed by processor 104 over a given period of time. Additionally or alternatively, telemetry data 108 may identify, indicate, and/or specify how many of each of those instructions were executed by processor 104 over the given period of time. For example, telemetry data 108 in FIG. 3 may identify, indicate, and/or specify that processor 104 executed the “ABS” instruction “10” times, the “ADD” instruction “20” times, the “ADDC” instruction “4” times, the “ADDT” instruction “14” times, the “LAR” instruction “0” times, the “SAR” instruction “10” times, etc., over a certain period of interest (e.g., over the last 10 milliseconds, 50 milliseconds, 100 milliseconds, etc.).

In some examples, controller 102 may track telemetry data 108 received from processor 104 over the period of interest. For example, controller 102 may track and/or monitor the number and/or count of each instruction executed by processor 104 over the period of interest. In this example, controller 102 may update its record and/or database of telemetry data 108 based on incoming information received from processor 104 via communication bus 112.

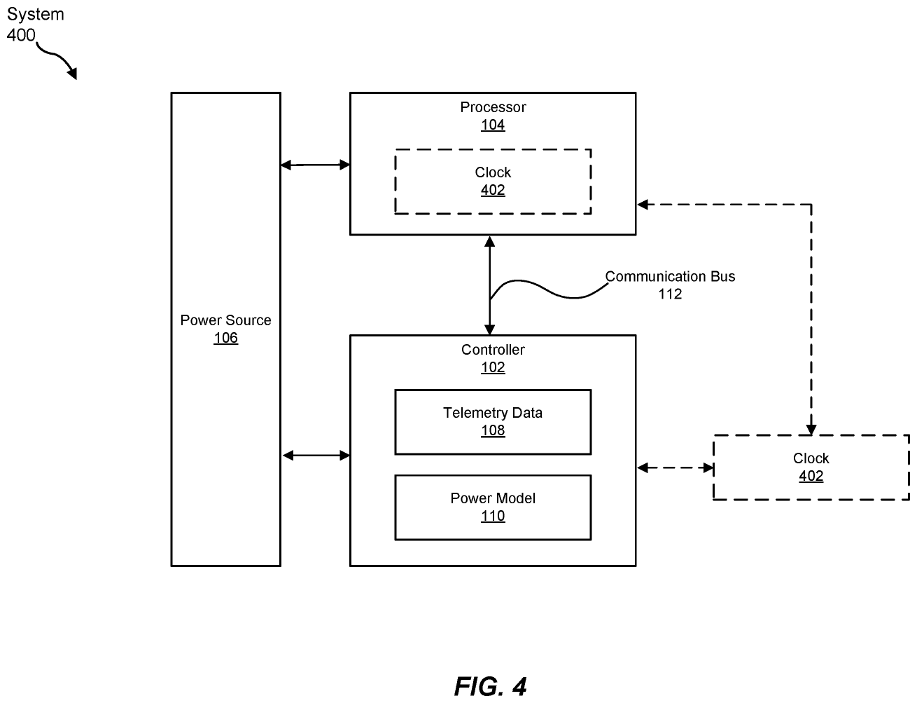

FIG. 4 illustrates an exemplary system 400 for regulating power consumption of processors based on telemetry data. In some examples, system 400 may include and/or represent certain devices, components, and/or features that perform and/or provide functionalities that are similar and/or identical to those described above in connection with any of FIGS. 1-3. As illustrated in FIG. 4, system 400 may include and/or represent controller 102, processor 104, power source 106, and/or a clock 402. In some examples, clock 402 may generate and/or provide clock signal 202 that triggers and/or controls the execution of instructions on processor 104. Accordingly, processor 104 may execute one or more instructions on every falling and/or rising edge of clock signal 202.

In some examples, clock 402 may be integrated into and/or represent part of processor 104. In other examples, clock 402 may be external to processor 104 and/or communicatively coupled to processor 104. In one example, clock 402 may be configurable and/or programmable to or by controller 102. Additionally or alternatively, clock 402 may be configurable and/or programmable to or by processor 104.

In some examples, the various apparatuses, devices, and systems described in connection with FIGS. 1-4 may include and/or represent one or more additional circuits, components, and/or features that are not necessarily illustrated and/or labeled in FIGS. 1-4. For example, the apparatuses, devices, and systems illustrated in FIGS. 1-4 may also include and/or represent additional analog and/or digital circuitry, onboard logic, transistors, radio-frequency (RF) transmitters, RF receivers, transceivers, antennas, resistors, capacitors, diodes, inductors, switches, registers, flipflops, digital logic, connections, traces, buses, semiconductor (e.g., silicon) devices and/or structures, processing devices, storage devices, circuit boards, sensors, packages, substrates, housings, combinations or variations of one or more of the same, and/or any other suitable components. In certain implementations, one or more of these additional circuits, components, and/or features may be inserted and/or applied between any of the existing circuits, components, and/or features illustrated in FIGS. 1-4 consistent with the aims and/or objectives described herein. Accordingly, the couplings and/or connections described with reference to FIGS. 1-4 may be direct connections with no intermediate components, devices, and/or nodes or indirect connections with one or more intermediate components, devices, and/or nodes.

In some examples, the phrase “to couple” and/or the term “coupling”, as used herein, may refer to a direct connection and/or an indirect connection. For example, a direct coupling between two components may constitute and/or represent a coupling in which those two components are directly connected to each other by a single node that provides continuity from one of those two components to the other. In other words, the direct coupling may exclude and/or omit any additional components between those two components.

Additionally or alternatively, an indirect coupling between two components may constitute and/or represent a coupling in which those two components are indirectly connected to each other by multiple nodes that fail to provide continuity from one of those two components to the other. In other words, the indirect coupling may include and/or incorporate at least one additional component between those two components.

In some examples, one or more components and/or features illustrated in FIGS. 1-4 may be excluded and/or omitted from the various apparatuses, devices, and/or systems described in connection with FIGS. 1-4. In addition, although some of the descriptions provided above are directed to the configurations of the various apparatuses, devices, and/or systems, those apparatuses, devices, and/or systems may perform and/or execute any of the actions, tasks, and/or services described above in the context of such configurations. For example, even though some of the above descriptions are directed to controller 102 being configured to determine that the amount of power consumed by processor 104 exceeds a threshold, controller 102 may also actually make such a determination. Similarly, even though some of the above descriptions are directed to controller 102 being configured to reduce the power consumption of processor 104, controller 102 may also actually reduce such power consumption.

FIG. 5 is a flow diagram of an exemplary method 500 for configuring, assembling, and/or programming apparatuses, devices, or systems capable of regulating power consumption of processors based on telemetry data. In one example, the steps shown in FIG. 5 may be achieved and/or accomplished by a computing equipment manufacturer or subcontractor that manufactures and/or produces computing devices. Additionally or alternatively, the steps shown in FIG. 5 may incorporate and/or involve certain sub-steps and/or variations consistent with the descriptions provided above in connection with FIGS. 1-4.

As illustrated in FIG. 5, method 500 may include the step of communicatively coupling a controller to a processor (510). Step 510 may be performed in a variety of ways, including any of those described above in connection with FIGS. 1-4. For example, a computing equipment manufacturer or subcontractor may communicatively couple a controller to a processor.

Method 500 may also include the step of configuring the controller to determine, based at least in part on telemetry data received from the processor, that an amount of power consumed by the processor exceeds a threshold (520). Step 520 may be performed in a variety of ways, including any of those described above in connection with FIGS. 1-4. For example, the computing equipment manufacturer or subcontractor may configure and/or program the controller to determine, based at least in part on telemetry data received from the processor, that an amount of power consumed by the processor exceeds a threshold.

Method 500 may further include the step of configuring the controller to cause the processor to reduce power consumption in response to determining that the amount of power exceeds the threshold (530). Step 530 may be performed in a variety of ways, including any of those described above in connection with FIGS. 1-4. For example, the computing equipment manufacturer or subcontractor may configure and/or program the controller to cause the processor to reduce power consumption in response to determining that the amount of power exceeds the threshold.

### EXAMPLE EMBODIMENTS

Example 1: An apparatus comprising a processor and a controller communicatively coupled to the processor, wherein the controller is configured to (1) determine, based at least in part on telemetry data received from the processor, that an amount of power consumed by the processor exceeds a threshold and (2) cause the processor to reduce power consumption in response to determining that the amount of power exceeds the threshold.

Example 2: The apparatus of Example 1, wherein the processor comprises a digital signal processor, the telemetry data comprises evidence of a plurality of instructions executed by the digital signal processor during a certain period, and the controller is communicatively coupled to the digital signal processor via a communication bus configured to indicate the plurality of instructions.

Example 3: The apparatus of either Example 1 or Example 2, wherein the communication bus comprises a plurality of signals that collectively indicate, to the controller, one or more instructions executed by the digital signal processor each clock cycle.

Example 4: The apparatus of any of Examples 1-3, wherein the communication bus comprises a serial bus that indicates, to the controller, one or more instructions executed by the digital signal processor each clock cycle.

Example 5: The apparatus of any of Examples 1-4, wherein the controller is further configured to estimate the amount of power consumed by the processor by applying the evidence of the plurality of instructions executed by the digital signal processor to a power model.

Example 6: The apparatus of any of Examples 1-5, wherein the controller is further configured to estimate the amount of power consumed by the processor by weighting the plurality of instructions commensurate with amounts of power needed by the processor to execute the plurality of instructions according to the power model.

Example 7: The apparatus of any of Examples 1-6, wherein the power model comprises at least one of (1) a machine learning model trained using linear algebra or deep learning and/or (2) a lookup table.

Example 8: The apparatus of any of Examples 1-7, wherein (1) the threshold is based at least in part on an amount of power that is available for consumption by the processor and (2) the controller is further configured to cause the processor to reduce the power consumption to avoid exceeding the amount of power that is available for consumption by the processor.

Example 9: The apparatus of any of Examples 1-8, further comprising a battery configured to source the amount of power that is available for consumption by the processor.

Example 10: The apparatus of any of Examples 1-9, wherein the controller is further configured to cause the processor to reduce the power consumption by at least one of (1) slowing a clock whose frequency controls a rate at which the processor executes instructions, (2) lengthening one or more pulses of a clock that controls a rate at which the processor executes instructions, (3) reducing a supply voltage provided to the processor, (4) slowing a rate at which the processor issues instructions for execution, and/or (5) causing the processor to transition from executing one instruction set to executing another instruction set.

Example 11: The apparatus of any of Examples 1-10, wherein the controller is further configured to cause the processor to reduce the power consumption such that the processor consumes an amount of power that complies with the threshold.

Example 12: A system comprising (1) a power source, (2) a processor configured to draw power from the power source, and (3) a controller communicatively coupled to the processor, wherein the controller is configured to (A) determine, based at least in part on telemetry data received from the processor, that an amount of power consumed by the processor exceeds a threshold and (B) cause the processor to reduce power consumption in response to determining that the amount of power exceeds the threshold.

Example 13: The system of Example 12, wherein the processor comprises a digital signal processor, the telemetry data comprises evidence of a plurality of instructions executed by the digital signal processor during a certain period, and the controller is communicatively coupled to the digital signal processor via a communication bus configured to indicate the plurality of instructions.

Example 14: The system of either Example 12 or Example 13, wherein the communication bus comprises a plurality of signals that collectively indicate, to the controller, one or more instructions executed by the digital signal processor each clock cycle.

Example 15: The system of any of Examples 12-14, wherein the communication bus comprises a serial bus that indicates, to the controller, one or more instructions executed by the digital signal processor each clock cycle.

Example 16: The system of any of Examples 12-15, wherein the controller is further configured to estimate the amount of power consumed by the processor by applying the evidence of the plurality of instructions executed by the digital signal processor to a power model.

Example 17: The system of any of Examples 12-16, wherein the controller is further configured to estimate the amount of power consumed by the processor by weighting the plurality of instructions commensurate with amounts of power needed by the processor to execute the plurality of instructions according to the power model.

Example 18: The system of any of Examples 12-17, wherein the power model comprises at least one of (1) a machine learning model trained using linear algebra or deep learning and/or (2) a lookup table.

Example 19: The system of any of Examples 12-18, wherein (1) the threshold is based at least in part on an amount of power that is available for consumption by the processor and (2) the controller is further configured to cause the processor to reduce the power consumption to avoid exceeding the amount of power that is available for consumption by the processor.

Example 20: A method comprising communicatively coupling a controller to a processor and configuring the controller to determine, based at least in part on telemetry data received from the processor, that an amount of power consumed by the processor exceeds a threshold and to cause the processor to reduce power consumption in response to determining that the amount of power exceeds the threshold.

Embodiments of the present disclosure may include or be implemented in-conjunction with various types of artificial-reality systems. Artificial reality is a form of reality that has been adjusted in some manner before presentation to a user, which may include, for example, a virtual reality, an augmented reality, a mixed reality, a hybrid reality, or some combination and/or derivative thereof. Artificial-reality content may include completely computer-generated content or computer-generated content combined with captured (e.g., real-world) content. The artificial-reality content may include video, audio, haptic feedback, or some combination thereof, any of which may be presented in a single channel or in multiple channels (such as stereo video that produces a three-dimensional (3D) effect to the viewer). Additionally, in some embodiments, artificial reality may also be associated with applications, products, accessories, services, or some combination thereof, that are used to, for example, create content in an artificial reality and/or are otherwise used in (e.g., to perform activities in) an artificial reality.

Artificial-reality systems may be implemented in a variety of different form factors and configurations. Some artificial-reality systems may be designed to work without near-eye displays (NEDs). Other artificial-reality systems may include an NED that also provides visibility into the real world (such as, e.g., augmented-reality system 600 in FIG. 6) or that visually immerses a user in an artificial reality (such as, e.g., virtual-reality system 700 in FIG. 7). While some artificial-reality devices may be self-contained systems, other artificial-reality devices may communicate and/or coordinate with external devices to provide an artificial-reality experience to a user. Examples of such external devices include handheld controllers, mobile devices, desktop computers, devices worn by a user, devices worn by one or more other users, and/or any other suitable external system.

Turning to FIG. 6, augmented-reality system 600 may include an eyewear device 602 with a frame 610 configured to hold a left display device 615(A) and a right display device 615(B) in front of a user's eyes. Display devices 615(A) and 615(B) may act together or independently to present an image or series of images to a user. While augmented-reality system 600 includes two displays, embodiments of this disclosure may be implemented in augmented-reality systems with a single NED or more than two NEDs.

In some embodiments, augmented-reality system 600 may include one or more sensors, such as sensor 640. Sensor 640 may generate measurement signals in response to motion of augmented-reality system 600 and may be located on substantially any portion of frame 610. Sensor 640 may represent one or more of a variety of different sensing mechanisms, such as a position sensor, an inertial measurement unit (IMU), a depth camera assembly, a structured light emitter and/or detector, or any combination thereof. In some embodiments, augmented-reality system 600 may or may not include sensor 640 or may include more than one sensor. In embodiments in which sensor 640 includes an IMU, the IMU may generate calibration data based on measurement signals from sensor 640. Examples of sensor 640 may include, without limitation, accelerometers, gyroscopes, magnetometers, other suitable types of sensors that detect motion, sensors used for error correction of the IMU, or some combination thereof.

In some examples, augmented-reality system 600 may also include a microphone array with a plurality of acoustic transducers 620(A)-620(J), referred to collectively as acoustic transducers 620. Acoustic transducers 620 may represent transducers that detect air pressure variations induced by sound waves. Each acoustic transducer 620 may be configured to detect sound and convert the detected sound into an electronic format (e.g., an analog or digital format). The microphone array in FIG. 6 may include, for example, ten acoustic transducers: 620(A) and 620(B), which may be designed to be placed inside a corresponding ear of the user, acoustic transducers 620(C), 620(D), 620(E), 620(F), 620(G), and 620(H), which may be positioned at various locations on frame 610, and/or acoustic transducers 620(1) and 620(J), which may be positioned on a corresponding neckband 605.

In some embodiments, one or more of acoustic transducers 620(A)-(J) may be used as output transducers (e.g., speakers). For example, acoustic transducers 620(A) and/or 620(B) may be earbuds or any other suitable type of headphone or speaker.

The configuration of acoustic transducers 620 of the microphone array may vary. While augmented-reality system 600 is shown in FIG. 6 as having ten acoustic transducers 620, the number of acoustic transducers 620 may be greater or less than ten. In some embodiments, using higher numbers of acoustic transducers 620 may increase the amount of audio information collected and/or the sensitivity and accuracy of the audio information. In contrast, using a lower number of acoustic transducers 620 may decrease the computing power required by an associated controller 650 to process the collected audio information. In addition, the position of each acoustic transducer 620 of the microphone array may vary. For example, the position of an acoustic transducer 620 may include a defined position on the user, a defined coordinate on frame 610, an orientation associated with each acoustic transducer 620, or some combination thereof.

Acoustic transducers 620(A) and 620(B) may be positioned on different parts of the user's ear, such as behind the pinna, behind the tragus, and/or within the auricle or fossa. Or, there may be additional acoustic transducers 620 on or surrounding the ear in addition to acoustic transducers 620 inside the ear canal. Having an acoustic transducer 620 positioned next to an ear canal of a user may enable the microphone array to collect information on how sounds arrive at the ear canal. By positioning at least two of acoustic transducers 620 on either side of a user's head (e.g., as binaural microphones), augmented-reality system 600 may simulate binaural hearing and capture a 3D stereo sound field around about a user's head. In some embodiments, acoustic transducers 620(A) and 620(B) may be connected to augmented reality system 600 via a wired connection 630, and in other embodiments acoustic transducers 620(A) and 620(B) may be connected to augmented-reality system 600 via a wireless connection (e.g., a BLUETOOTH connection). In still other embodiments, acoustic transducers 620(A) and 620(B) may not be used at all in conjunction with augmented-reality system 600.

Acoustic transducers 620 on frame 610 may be positioned in a variety of different ways, including along the length of the temples, across the bridge, above or below display devices 615(A) and 615(B), or some combination thereof. Acoustic transducers 620 may also be oriented such that the microphone array is able to detect sounds in a wide range of directions surrounding the user wearing the augmented-reality system 600. In some embodiments, an optimization process may be performed during manufacturing of augmented-reality system 600 to determine relative positioning of each acoustic transducer 620 in the microphone array.

In some examples, augmented-reality system 600 may include or be connected to an external device (e.g., a paired device), such as neckband 605. Neckband 605 generally represents any type or form of paired device. Thus, the following discussion of neckband 605 may also apply to various other paired devices, such as charging cases, smart watches, smart phones, wrist bands, other wearable devices, hand-held controllers, tablet computers, laptop computers, other external compute devices, etc.

As shown, neckband 605 may be coupled to eyewear device 602 via one or more connectors. The connectors may be wired or wireless and may include electrical and/or non-electrical (e.g., structural) components. In some cases, eyewear device 602 and neckband 605 may operate independently without any wired or wireless connection between them. While FIG. 6 illustrates the components of eyewear device 602 and neckband 605 in example locations on eyewear device 602 and neckband 605, the components may be located elsewhere and/or distributed differently on eyewear device 602 and/or neckband 605. In some embodiments, the components of eyewear device 602 and neckband 605 may be located on one or more additional peripheral devices paired with eyewear device 602, neckband 605, or some combination thereof.

Pairing external devices, such as neckband 605, with augmented-reality eyewear devices may enable the eyewear devices to achieve the form factor of a pair of glasses while still providing sufficient battery and computation power for expanded capabilities. Some or all of the battery power, computational resources, and/or additional features of augmented-reality system 600 may be provided by a paired device or shared between a paired device and an eyewear device, thus reducing the weight, heat profile, and form factor of the eyewear device overall while still retaining desired functionality. For example, neckband 605 may allow components that would otherwise be included on an eyewear device to be included in neckband 605 since users may tolerate a heavier weight load on their shoulders than they would tolerate on their heads. Neckband 605 may also have a larger surface area over which to diffuse and disperse heat to the ambient environment. Thus, neckband 605 may allow for greater battery and computation capacity than might otherwise have been possible on a stand-alone eyewear device. Since weight carried in neckband 605 may be less invasive to a user than weight carried in eyewear device 602, a user may tolerate wearing a lighter eyewear device and carrying or wearing the paired device for greater lengths of time than a user would tolerate wearing a heavy standalone eyewear device, thereby enabling users to more fully incorporate artificial-reality environments into their day-to-day activities.

Neckband 605 may be communicatively coupled with eyewear device 602 and/or to other devices. These other devices may provide certain functions (e.g., tracking, localizing, depth mapping, processing, storage, etc.) to augmented-reality system 600. In the embodiment of FIG. 6, neckband 605 may include two acoustic transducers (e.g., 620(I) and 620(J)) that are part of the microphone array (or potentially form their own microphone subarray). Neckband 605 may also include a controller 625 and a power source 635.

Acoustic transducers 620(I) and 620(J) of neckband 605 may be configured to detect sound and convert the detected sound into an electronic format (analog or digital). In the embodiment of FIG. 6, acoustic transducers 620(I) and 620(J) may be positioned on neckband 605, thereby increasing the distance between the neckband acoustic transducers 620(I) and 620(J) and other acoustic transducers 620 positioned on eyewear device 602. In some cases, increasing the distance between acoustic transducers 620 of the microphone array may improve the accuracy of beamforming performed via the microphone array. For example, if a sound is detected by acoustic transducers 620(C) and 620(D) and the distance between acoustic transducers 620(C) and 620(D) is greater than, e.g., the distance between acoustic transducers 620(D) and 620(E), the determined source location of the detected sound may be more accurate than if the sound had been detected by acoustic transducers 620(D) and 620(E).

Controller 625 of neckband 605 may process information generated by the sensors on neckband 605 and/or augmented-reality system 600. For example, controller 625 may process information from the microphone array that describes sounds detected by the microphone array. For each detected sound, controller 625 may perform a direction-of-arrival (DOA) estimation to estimate a direction from which the detected sound arrived at the microphone array. As the microphone array detects sounds, controller 625 may populate an audio data set with the information. In embodiments in which augmented-reality system 600 includes an inertial measurement unit, controller 625 may compute all inertial and spatial calculations from the IMU located on eyewear device 602. A connector may convey information between augmented-reality system 600 and neckband 605 and between augmented-reality system 600 and controller 625. The information may be in the form of optical data, electrical data, wireless data, or any other transmittable data form. Moving the processing of information generated by augmented reality system 600 to neckband 605 may reduce weight and heat in eyewear device 602, making it more comfortable to the user.

Power source 635 in neckband 605 may provide power to eyewear device 602 and/or to neckband 605. Power source 635 may include, without limitation, lithium-ion batteries, lithium-polymer batteries, primary lithium batteries, alkaline batteries, or any other form of power storage. In some cases, power source 635 may be a wired power source. Including power source 635 on neckband 605 instead of on eyewear device 602 may help better distribute the weight and heat generated by power source 635.

As noted, some artificial-reality systems may, instead of blending an artificial reality with actual reality, substantially replace one or more of a user's sensory perceptions of the real world with a virtual experience. One example of this type of system is a head-worn display system, such as virtual-reality system 700 in FIG. 7, that mostly or completely covers a user's field of view. Virtual-reality system 700 may include a front rigid body 702 and a band 704 shaped to fit around a user's head. Virtual-reality system 700 may also include output audio transducers 706(A) and 706(B). Furthermore, while not shown in FIG. 7, front rigid body 702 may include one or more electronic elements, including one or more electronic displays, one or more inertial measurement units (IMUs), one or more tracking emitters or detectors, and/or any other suitable device or system for creating an artificial-reality experience.

Artificial-reality systems may include a variety of types of visual feedback mechanisms. For example, display devices in augmented-reality system 600 and/or virtual-reality system 700 may include one or more liquid crystal displays (LCDs), light emitting diode (LED) displays, microLED displays, organic LED (OLED) displays, digital light project (DLP) micro-displays, liquid crystal on silicon (LCoS) micro-displays, and/or any other suitable type of display screen. These artificial-reality systems may include a single display screen for both eyes or may provide a display screen for each eye, which may allow for additional flexibility for varifocal adjustments or for correcting a user's refractive error. Some of these artificial-reality systems may also include optical subsystems having one or more lenses (e.g., concave or convex lenses, Fresnel lenses, adjustable liquid lenses, etc.) through which a user may view a display screen. These optical subsystems may serve a variety of purposes, including to collimate (e.g., make an object appear at a greater distance than its physical distance), to magnify (e.g., make an object appear larger than its actual size), and/or to relay (to, e.g., the viewer's eyes) light. These optical subsystems may be used in a non-pupil-forming architecture (such as a single lens configuration that directly collimates light but results in so-called pincushion distortion) and/or a pupil-forming architecture (such as a multi-lens configuration that produces so-called barrel distortion to nullify pincushion distortion).

In addition to or instead of using display screens, some of the artificial-reality systems described herein may include one or more projection systems. For example, display devices in augmented-reality system 600 and/or virtual-reality system 700 may include micro-LED projectors that project light (using, e.g., a waveguide) into display devices, such as clear combiner lenses that allow ambient light to pass through. The display devices may refract the projected light toward a user's pupil and may enable a user to simultaneously view both artificial-reality content and the real world. The display devices may accomplish this using any of a variety of different optical components, including waveguide components (e.g., holographic, planar, diffractive, polarized, and/or reflective waveguide elements), light-manipulation surfaces and elements (such as diffractive, reflective, and refractive elements and gratings), coupling elements, etc. Artificial-reality systems may also be configured with any other suitable type or form of image projection system, such as retinal projectors used in virtual retina displays.

The artificial-reality systems described herein may also include various types of computer vision components and subsystems. For example, augmented-reality system 600 and/or virtual-reality system 700 may include one or more optical sensors, such as two-dimensional (2D) or 3D cameras, structured light transmitters and detectors, time-of-flight depth sensors, single-beam or sweeping laser rangefinders, 3D LiDAR sensors, and/or any other suitable type or form of optical sensor. An artificial-reality system may process data from one or more of these sensors to identify a location of a user, to map the real world, to provide a user with context about real-world surroundings, and/or to perform a variety of other functions.

The artificial-reality systems described herein may also include one or more input and/or output audio transducers. Output audio transducers may include voice coil speakers, ribbon speakers, electrostatic speakers, piezoelectric speakers, bone conduction transducers, cartilage conduction transducers, tragus-vibration transducers, and/or any other suitable type or form of audio transducer. Similarly, input audio transducers may include condenser microphones, dynamic microphones, ribbon microphones, and/or any other type or form of input transducer. In some embodiments, a single transducer may be used for both audio input and audio output.

In some embodiments, the artificial-reality systems described herein may also include tactile (i.e., haptic) feedback systems, which may be incorporated into headwear, gloves, body suits, handheld controllers, environmental devices (e.g., chairs, floormats, etc.), and/or any other type of device or system. Haptic feedback systems may provide various types of cutaneous feedback, including vibration, force, traction, texture, and/or temperature. Haptic feedback systems may also provide various types of kinesthetic feedback, such as motion and compliance. Haptic feedback may be implemented using motors, piezoelectric actuators, fluidic systems, and/or a variety of other types of feedback mechanisms. Haptic feedback systems may be implemented independent of other artificial-reality devices, within other artificial-reality devices, and/or in conjunction with other artificial-reality devices.

By providing haptic sensations, audible content, and/or visual content, artificial-reality systems may create an entire virtual experience or enhance a user's real-world experience in a variety of contexts and environments. For instance, artificial-reality systems may assist or extend a user's perception, memory, or cognition within a particular environment. Some systems may enhance a user's interactions with other people in the real world or may enable more immersive interactions with other people in a virtual world. Artificial-reality systems may also be used for educational purposes (e.g., for teaching or training in schools, hospitals, government organizations, military organizations, business enterprises, etc.), entertainment purposes (e.g., for playing video games, listening to music, watching video content, etc.), and/or for accessibility purposes (e.g., as hearing aids, visual aids, etc.). The embodiments disclosed herein may enable or enhance a user's artificial-reality experience in one or more of these contexts and environments and/or in other contexts and environments.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference may be made to any claims appended hereto and their equivalents in determining the scope of the present disclosure.

Unless otherwise noted, the terms “connected to” and “coupled to” (and their derivatives), as used in the specification and/or claims, are to be construed as permitting both direct and indirect (i.e., via other elements or components) connection. In addition, the terms “a” or “an,” as used in the specification and/or claims, are to be construed as meaning “at least one of.” Finally, for ease of use, the terms “including” and “having” (and their derivatives), as used in the specification and/or claims, are interchangeable with and have the same meaning as the word “comprising.”

What is claimed is:

1. An apparatus comprising:
a processor; and
a controller communicatively coupled to the processor, wherein the controller is configured to:
determine, based at least in part on telemetry data received from the processor, that an amount of power consumed by the processor exceeds a threshold; and
cause the processor to reduce power consumption in response to determining that the amount of power exceeds the threshold.

2. The apparatus of claim 1, wherein:
the processor comprises a digital signal processor;
the telemetry data comprises evidence of a plurality of instructions executed by the digital signal processor during a certain period; and
the controller is communicatively coupled to the digital signal processor via a communication bus configured to indicate the plurality of instructions.

3. The apparatus of claim 2, wherein the communication bus comprises a plurality of signals that collectively indicate, to the controller, one or more instructions executed by the digital signal processor each clock cycle.

4. The apparatus of claim 2, wherein the communication bus comprises a serial bus that indicates, to the controller, one or more instructions executed by the digital signal processor each clock cycle.

5. The apparatus of claim 2, wherein the controller is further configured to estimate the amount of power consumed by the processor by applying the evidence of the plurality of instructions executed by the digital signal processor to a power model.

6. The apparatus of claim 5, wherein the controller is further configured to estimate the amount of power consumed by the processor by weighting the plurality of instructions commensurate with amounts of power needed by the processor to execute the plurality of instructions according to the power model.

7. The apparatus of claim 5, wherein the power model comprises at least one of:
a machine learning model trained using linear algebra or deep learning; or
a lookup table.

8. The apparatus of claim 1, wherein:
the threshold is based at least in part on an amount of power that is available for consumption by the processor; and
the controller is further configured to cause the processor to reduce the power consumption to avoid exceeding the amount of power that is available for consumption by the processor.

9. The apparatus of claim 8, further comprising a battery configured to source the amount of power that is available for consumption by the processor.

10. The apparatus of claim 1, wherein the controller is further configured to cause the processor to reduce the power consumption by at least one of:
slowing a clock whose frequency controls a rate at which the processor executes instructions;
lengthening one or more pulses of a clock that controls a rate at which the processor executes instructions;
reducing a supply voltage provided to the processor;
slowing a rate at which the processor issues instructions for execution; or
causing the processor to transition from executing one instruction set to executing another instruction set.

11. The apparatus of claim 1, wherein the controller is further configured to cause the processor to reduce the power consumption such that the processor consumes an amount of power that complies with the threshold.

12. A system comprising:
a power source;
a processor configured to draw power from the power source; and
a controller communicatively coupled to the processor, wherein the controller is configured to:
determine, based at least in part on telemetry data received from the processor, that an amount of power consumed by the processor exceeds a threshold; and
cause the processor to reduce power consumption in response to determining that the amount of power exceeds the threshold.

13. The system of claim 12, wherein:
the processor comprises a digital signal processor;
the telemetry data comprises evidence of a plurality of instructions executed by the digital signal processor during a certain period; and
the controller is communicatively coupled to the digital signal processor via a communication bus configured to indicate the plurality of instructions.

14. The system of claim 13, wherein the communication bus comprises a plurality of signals that collectively indicate, to the controller, one or more instructions executed by the digital signal processor each clock cycle.

15. The system of claim 13, wherein the communication bus comprises a serial bus that indicates, to the controller, one or more instructions executed by the digital signal processor each clock cycle.

16. The system of claim 13, wherein the controller is further configured to estimate the amount of power consumed by the processor by applying the evidence of the plurality of instructions executed by the digital signal processor to a power model.

17. The system of claim 16, wherein the controller is further configured to estimate the amount of power consumed by the processor by weighting the plurality of instructions commensurate with amounts of power needed by the processor to execute the plurality of instructions according to the power model.

18. The system of claim 16, wherein the power model comprises at least one of:
a machine learning model trained using linear algebra or deep learning; or
a lookup table.

19. The system of claim 12, wherein:
the threshold is based at least in part on an amount of power that is available for consumption by the processor; and
the controller is further configured to cause the processor to reduce the power consumption to avoid exceeding the amount of power that is available for consumption by the processor.

20. A method comprising:
communicatively coupling a controller to a processor; and
configuring the controller to:
determine, based at least in part on telemetry data received from the processor, that an amount of power consumed by the processor exceeds a threshold; and
cause the processor to reduce power consumption in response to determining that the amount of power exceeds the threshold.
